(19) United States
(12) Patent Application Publication
(10) Pub. No.: US 2024/0317588 A1
(43) Pub. Date: Sep. 26, 2024

(54) Method of Producing Graphene and Holey Graphene and Electrode for the Same

(71) Applicant: Technology Innovation Institute - Sole Proprietorship LLC, Masdar City, Abu Dhabi (AE)

(72) Inventors: Monserrat Gutierrez MUNOZ, Abu Dhabi (AE); Nitul RAJPUT, Khalifa City (AE); Meriam MOHAMMEDTURE, Abu Dhabi (AE); Alya ALHAMMADI, Abu Dhabi (AE); Nesma ABOULKHAIR, Abu Dhabi (AE); Eva CORREIA, Abu Dhabi (AE)

(73) Assignee: Technology Innovation Institute - Sole Proprietorship LLC, Masdar City, Abu Dhabi (AE)

(21) Appl. No.: 18/531,961

(22) Filed: Dec. 7, 2023

Related U.S. Application Data
(60) Provisional application No. 63/386,567, filed on Dec. 8, 2022.

(51) Int. Cl. C01B 32/19; C25B 1/135; C25B 11/031; C25B 11/043; C25B 11/046; C25B 13/08; C25B 15/08

(52) U.S. Cl. CPC C01B 32/19; C25B 1/135; C25B 11/031; C25B 11/043; C25B 11/046; C25B 13/08; C25B 15/087

(57) ABSTRACT

The present disclosure describes methods of producing graphene and holey graphene in a single electrochemical cell using a scalable and simple process. The method makes use of an electrode in the form of a triply periodic minimal surface having a defined unit cell geometry, which may be defined by a series of equations.

### CROSS-REFERENCE TO RELATED APPLICATIONS

This application claims priority to U.S. Provisional Patent Application No. 63/386,567, which was filed on Dec. 8, 2022, the entire contents of which are incorporated by reference herein.

### FIELD

The present disclosure relates generally to the production of graphene and holey graphene from the same electrochemical cell. More specifically, this disclosure relates to a novel electrode which may be used for the production of graphene and holey graphene in one scalable and efficient process.

### BACKGROUND

Graphene is an allotrope of carbon which exhibits numerous useful properties, such as high strength, flexibility, and electrical and thermal conductivity. There are many applications which benefit from the properties of graphene, such as targeted drug delivery devices, transistors, membrane filtration, and ultra-sensitive sensors, among others. Given the incredible demand for graphene, scalable and cost-effective methods of production are important areas of research. One method of producing graphene is mechanical exfoliation, which produces large sheets of graphene with few defects. However, this method only provides a small number of sheets on supported substrates and is not scalable. Chemical vapor deposition and the oxidation of graphite to graphene oxide may also be used to produce graphene, but these methods suffer from imperfectly formed graphene and limited scalability.

One structural derivative of graphene is holey graphene, or perforated graphene. Holey graphene contains in-plane holes which may improve particular properties relative to graphene. For example, holey graphene may exhibit significantly different electronic properties than graphene which may be beneficial for semiconducting applications, and the holes in the structure may facilitate ion transport in energy storage applications.

Methods of producing holey graphene include electron or ion bombardment, which is precise but time-consuming and best suited to small scales, and nanolithographic etching, which can result in layers of photoresist unable to be removed from the resulting holey graphene. The production of graphene and holey graphene simultaneously has not yet been realized, and there remains a need for scalable and reliable methods of producing these important materials.

### SUMMARY

In embodiments, there is provided a method of producing graphene and holey graphene, the method including: providing an electrochemical cell including a cathodic compartment containing a cathode and an initial cathodic solution, and an anodic compartment containing an anode and an initial anodic solution; exfoliating the anode to produce graphene in a final anodic solution; separating the graphene in the final anodic solution into a first portion of graphene and a second portion of graphene; removing the first portion of graphene from the anodic compartment; filtering the first portion of graphene to isolate the graphene; transferring the second portion of graphene from the anodic compartment to the cathodic compartment; treating the second portion of graphene to produce holey graphene in a final cathodic solution; and filtering the final cathodic solution to isolate the holey graphene.

In embodiments, the cathodic compartment and the anodic compartment are separated by an anionic membrane. In embodiments, the anionic membrane according to any of the above embodiments includes polystyrene, polyethylene, polysulfone, ammonium, or combinations thereof. In embodiments, the anode according to any of the above embodiments includes graphite. In embodiments, the cathode according to any of the above embodiments includes a metal or a metallic alloy. In embodiments, the cathode according to any of the above embodiments is in the form of a triply periodic minimal surface having a defined unit cell geometry. In embodiments, the defined unit cell geometry according to any of the above embodiments is a gyroid, a diamond, or a split-P.

In embodiments, the initial cathodic solution according to any of the above embodiments includes sulfuric acid, ammonium sulfate, or combinations thereof. In embodiments, the initial anodic solution according to any of the above embodiments includes sulfuric acid, ammonium sulfate, or combinations thereof. In embodiments, exfoliating the anode according to any of the above embodiments includes stirring, heating to a temperature of greater than or equal to about 10° C. to less than or equal to about 60° C., applying a voltage of greater than or equal to about −10 V to less than or equal to about 10 V, or combinations thereof. In embodiments, treating the second portion of graphene according to any of the above embodiments includes contacting the second portion of graphene with the initial anodic solution in the cathodic compartment, heating to a temperature of greater than or equal to 10° C. to less than or equal to 60° C., applying a voltage of greater than or equal to −10 V to less than or equal to 10 V, or combinations thereof. In embodiments, the method according to any of the above embodiments further includes centrifuging the final anodic solution to isolate the graphene, centrifuging the final cathodic solution to isolate the holey graphene, or centrifuging both the final anodic solution to isolate the graphene and the final cathodic solution to isolate the holey graphene. In embodiments, the method according to any of the above embodiments further includes recycling the final cathodic solution and the final anodic solution.

In embodiments, there is provided an electrode, including: a metal or a metallic alloy, wherein the electrode is in the form of a triply periodic minimal surface having a defined unit cell geometry. In embodiments, the defined unit cell geometry is a gyroid, a diamond, or a split-P. In embodiments, the gyroid is defined by the equation: c=sin(x) cos(y)+sin(y) cos(x), the diamond is defined by the equation: c=sin(x) sin(y) sin(z)+sin(x) cos(y)cos(z)+cos(x) sin(y)cos(z)+cos(x) cos(y) sin(z), and the split-P is defined by the equation: c=1.1(sin(2x) sin(z) cos(y)+sin(2y) sin(x) cos(z)+sin(2z) sin(y) cos(x))−0.2(cos(2x)cos(2y)+cos(2y)cos(2z)+cos(2z) cos(2x))−0.4(cos(2x)+cos(2y)+cos(2z)), wherein x, y, and z are Cartesian coordinates and c is an offset parameter.

In embodiments, the metal or metallic alloy according to any of the above embodiments includes aluminum, titanium, silicon, magnesium, iron, or combinations thereof. In embodiments, the electrode according to any of the above embodiments has a specific surface area of greater than or equal to about 1.0 mm²/mm³ to less than or equal to about 2.5 mm²/mm³. In embodiments, the electrode according to any of the above embodiments has a porosity of greater than or equal to about 60% to less than or equal to about 85%.

In embodiments, there is provided a method of producing graphene and holey graphene, using the electrode according to any of the above embodiments described herein. In embodiments, the method includes: providing an electrochemical cell including a cathodic compartment containing a cathode and an initial cathodic solution, and an anodic compartment containing an anode and an initial anodic solution; exfoliating the anode to produce graphene in a final anodic solution; separating the graphene in the final anodic solution into a first portion of graphene and a second portion of graphene; removing the first portion of graphene from the anodic compartment; filtering the first portion of graphene to isolate the graphene; transferring the second portion of graphene from the anodic compartment to the cathodic compartment; treating the second portion of graphene to produce holey graphene in a final cathodic solution; and filtering the final cathodic solution to isolate the holey graphene.

### DRAWINGS

Aspects, features, benefits, and advantages of the embodiments described herein will be apparent with regard to the following description, appended claims, and accompanying drawings where:

FIG. 1 is a flow chart of a method of producing graphene and holey graphene according to an embodiment of the present disclosure.

FIG. 2A, FIG. 2B, and FIG. 2C are modeled representations of single unit cells of triply periodic minimal surfaces, according to an embodiment of the present disclosure.

FIG. 3A is a modeled image of an electrode having a gyroid geometry and a specific surface area of 1.23 mm²/mm³, according to an embodiment of the present disclosure.

FIG. 3B is a modeled image of an electrode having a diamond geometry and a specific surface area of 1.23 mm²/mm³, according to an embodiment of the present disclosure.

FIG. 3C is a modeled image of an electrode having a split-P geometry and a specific surface area of 1.23 mm²/mm³, according to an embodiment of the present disclosure.

FIG. 4A is a modeled image of an electrode having a gyroid geometry and a specific surface area of 2.0 mm²/mm³, according to an embodiment of the present disclosure.

FIG. 4B is a modeled image of an electrode having a diamond geometry and a specific surface area of 2.0 mm²/mm³, according to an embodiment of the present disclosure.

FIG. 4C is a modeled image of an electrode having a split-P geometry and a specific surface area of 2.0 mm²/mm³, according to an embodiment of the present disclosure.

FIGS. 5A-5F are optical images of 3D-printed Titanium alloy electrodes, according to embodiments of the present disclosure. FIGS. 5A and 5D are electrodes having a gyroid geometry, FIGS. 5B and 5E are electrodes having a diamond geometry, and FIGS. 5C and 5F are electrodes having a split-P geometry.

FIGS. 6A and 6B are SEM images of the graphene flakes obtained from the oxidation (anodic) cell, according to embodiments of the present disclosure.

FIG. 7 is a graph of Raman shift obtained from the graphene flakes of the oxidation cell (anodic compartment), according to an embodiment of the present disclosure.

FIGS. 8A and 8B are an XPS survey scan and a high-resolution scan of the C1s peak obtained from the oxidized flakes, according to an embodiment of the present disclosure.

FIGS. 9A and 9B are SEM images of the holey graphene flakes obtained from the reduced cell (cathodic cell), according to an embodiment of the present disclosure.

FIG. 10 is a graph of pore-size distribution of the holes in the holey graphene flakes obtained by the present method, according to an embodiment of the present disclosure.

FIGS. 11A, 11B, 11C, and 11D are SEM images of graphene flakes (holey graphene) obtained from the reduced cell at a scale of 10 μm, 5 μm, 1 μm, and 3 μm, respectively, according to an embodiment of the present disclosure.

FIG. 12 is a graph of the Raman spectrum obtained from the graphene flakes of the reduced cell (cathodic cell), according to an embodiment of the present disclosure.

FIGS. 13A and 13B are an XPS survey spectrum and high-resolution C1s spectrum, respectively, obtained from the reduced flakes, according to an embodiment of the present disclosure.

### DETAILED DESCRIPTION

The present disclosure describes methods of producing graphene and holey graphene in one electrochemical cell. The method of the present disclosure is scalable, straightforward, and produces high quality graphene and holey graphene. Producing graphene and holey graphene via traditional methods typically requires two separate methods and sets of equipment and requires a significant amount of resources to produce both products. The present method, by contrast, allows the production of graphene and holey graphene in one system where the solutions used may be recycled to further reduce the footprint of the process. This method further uses an electrode specifically developed with high surface area and porosity, along with its excellent fluid contact properties. Described herein are a method of producing graphene and holey graphene from one continuous and simultaneously operating process, and an electrode for use in said method.

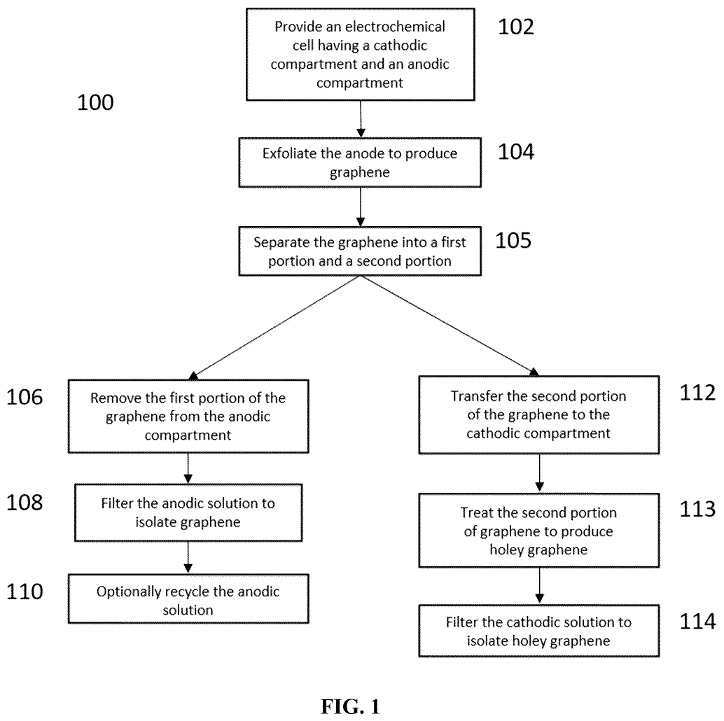

In embodiments, there is provided a method for producing graphene and holey graphene. As shown in FIG. 1, the method 100 may include steps of providing an electrochemical cell including a cathodic compartment containing a cathode and an initial cathodic solution and an anodic compartment containing an anode and an initial anodic solution 102, exfoliating the anode to produce graphene 104, separating the graphene in the final anodic solution into a first portion and a second portion 105, removing the first portion of the graphene from the anodic compartment 106, filtering the first portion of the anodic solution to isolate graphene 108, optionally recycling the anodic solution 110, transferring the second portion of the graphene to the cathodic compartment 112, treating the second portion of the graphene with the cathodic solution to produce holey graphene 113, and filtering the final cathodic solution to isolate holey graphene 114.

In embodiments, step 102 of the disclosed method includes providing an electrochemical cell which includes a cathodic compartment containing a cathode and a cathodic solution and an anodic compartment containing an anode and an anodic solution. The anode may, in embodiments, be formed from graphite. The cathode may be formed from a metal or a metallic alloy which may include aluminum or titanium. In embodiments, the cathode is formed from a composition which includes aluminum, silicon, magnesium, iron, manganese, copper, nickel, lead, antimony, titanium, zinc, or combinations thereof. In embodiments, the cathode has a defined unit cell geometry. The defined unit cell geometry may be a gyroid, a diamond, or a split-P. In embodiments, the cathodic compartment and the anodic compartment are separated by an anionic membrane. The anionic membrane may, in embodiments, include polystyrene, polyethylene, polysulfone, ammonium, or combinations thereof.

In embodiments, the cathodic solution is an initial cathodic solution. In embodiments, the initial cathodic solution includes sulfuric acid, ammonium sulfate, or combinations thereof. In embodiments, the initial cathodic solution includes greater than or equal to about 0.1 M sulfuric acid to less than or equal to about 3M sulfuric acid, for example, about 0.1 M, about 0.5 M, about 1 M, about 1.5 M, about 2 M, about 2.5 M, about 3 M, or any value contained within a range formed by any two of the preceding values.

In embodiments, the anodic solution is an initial anodic solution. In embodiments, the initial anodic solution includes sulfuric acid, ammonium sulfate, or combinations thereof. In embodiments, the initial anodic solution includes greater than or equal to about 0.1 M to less than or equal to about 3 M of sulfuric acid. For example, the concentration of sulfuric acid may be about 0.1 M to about 3 M, such as about 0.1 M, about 0.5 M, about 1 M, about 1.5 M, about 2 M, about 2.5 M, about 3 M, or any value contained within a range formed by any two of the preceding values. In embodiments, the cathodic solution and the anodic solution may have the same composition and concentration, and in other embodiments, the cathodic solution and anodic solution may have different compositions and/or concentrations.

In embodiments of the present disclosure, the method 100 includes step 104, exfoliating the anode to produce graphene in a final anodic solution. Step 104 may, in embodiments, include stirring, heating to a temperature of greater than or equal to about 10° C. to less than or equal to about 60° C., applying a voltage of greater than or equal to about −10 V to less than or equal to about 10 V, or combinations thereof. For example, step 104 may include stirring, such as a with a magnetic stirrer or other means of agitation known to those skilled in the art. In embodiments, step 104 may include heating to a temperature of greater than or equal to about 10° C. to less than or equal to about 60° C., for example about 10° C., about 15° C., about 20° C., about 25° C., about 30° C., about 35° C., about 40° C., about 45° C., about 50° C., about 55° C., about 60° C., or any value contained within a range formed by any two of the preceding values.

In embodiments, step 104 may include applying a voltage of greater than or equal to about −10 V to less than or equal to about 10 V, such as about −10 V, about −9 V, about −8 V, about −7 V, about −6 V, about −5 V, about −4 V, about −3 V, about −2 V, about −1 V, about 0 V, about 0.5 V, about 1 V, about 1.5 V, about 2 V, about 2.5 V, about 3 V, about 3.5 V, about 4 V, about 4.5 V, about 5 V, about 5 V, about 5.5 V, about 6 V, about 6.5 V, about 7 V, about 7.5 V, about 8 V, about 8.5 V, about 9 V, about 9.5 V, about 10 V, or any value contained within a range formed by any two of the preceding values. Step 104 may include any or all of stirring, heating, and applying a voltage as disclosed herein. In embodiments, step 104 may be performed over a period of greater than or equal to about 30 minutes to less than or equal to about 6 hours, for example about 30 minutes, about 1 hour, about 2 hours, about 3 hours, about 4 hours, about 5 hours, about 6 hours, or any value contained within a range formed by any two of the preceding values. In embodiments, step 104 of exfoliating the anode produces exfoliated graphite, also known as graphene. According to embodiments of the present disclosure, exfoliating the anode 104 produces graphene in a final anodic solution.

In embodiments, step 105 of the disclosed method includes separating the graphene produced in step 104 into a first portion and a second portion. In embodiments, the first portion of graphene and the second portion of graphene are equal in mass, volume, or other measurement. In embodiments, the first portion of graphene and the second portion of graphene are not equal, such that one portion is larger than the other in mass, volume, or other measurement.

In embodiments, step 106 of the disclosed method includes removing a first portion of the graphene in the final anodic solution from the anodic compartment. The first portion of the final anodic solution may be removed from the anodic compartment by any method known to those skilled in the art.

The method 100 may, in embodiments, include step 108, filtering the first portion of the graphene in the final anodic solution to isolate the graphene from the first portion of the final anodic solution. Any method of liquid/solid filtration known to those skilled in the art is acceptable for use in the methods of the present disclosure. In embodiments, step 108 of filtering the first portion of the graphene in the final anodic solution to isolate the graphene further includes centrifuging the final anodic solution to isolate the graphene.

In embodiments, step 110 of the disclosed method includes optionally recycling the first portion of the final anodic solution. In embodiments, recycling the first portion of the final anodic solution includes adjusting the concentration and components to those of the initial anodic solution. It is beneficial to recycle the solutions described herein to prevent waste and reduce costs associated with the method. Instead of preparing a fresh solution after each iteration of the present method, the cathodic and anodic solutions may be recycled and used multiple times, for example two times, three times, four times, five times, six times, seven times, eight times, nine times, ten times, and so forth. Recycling the solutions also prevents the need to dispose of large volumes of aqueous and organic solutions which may require special handling considerations. As described herein, in embodiments, the initial anodic solution includes sulfuric acid, ammonium sulfate, or combinations thereof. In embodiments, the initial anodic solution includes greater than or equal to about 0.1 M sulfuric acid to less than or equal to about 3 M sulfuric acid, for example, about 0.1 M, about 0.5 M, about 1 M, about 1.5 M, about 2 M, about 2.5 M, about 3 M, or any value contained within a range formed by any two of the preceding values. Adjusting the concentration and components of the first portion of the final anodic solution to those of the initial anodic solution may include adding an acid, adding a buffer, or combinations thereof. In embodiments, step 110 of the method is not performed.

In embodiments, step 112 of the disclosed method includes transferring the second portion of the graphene in the final anodic solution to the cathodic compartment. The second portion of graphene, in embodiments, includes a second portion of the graphene that was produced in step 104. The second portion of the graphene may be transferred into the cathodic compartment by any means known to those skilled in the art, such as passage through a tube, a cannula, or other passageway, or by removing the second portion of the graphene in the final anodic solution from the anodic compartment and placing it into the cathodic compartment. In embodiments, the second portion of graphene may be filtered from the final anodic solution before being transferred to the cathodic compartment. In embodiments, the second portion graphene may be placed in the cathodic compartment while still suspended in the final anodic solution.

In embodiments, the method 100 includes step 113 of treating the second portion of graphene to produce holey graphene in a final cathodic solution. In embodiments, the sulfuric acid, ammonium sulfate, or combination thereof in the cathodic solution reduces functional groups from the graphene which oxidizes in the cathodic compartment, forming pores in the graphene's structure which generates holey graphene. In embodiments, treating the second portion of the graphene 113 includes heating to a temperature of greater than or equal to about 10° C. to less than or equal to about 60° C., for example about 10° C., about 15° C., about 20° C., about 25° C., about 30° C., about 35° C., about 40° C., about 45° C., about 50° C., about 55° C., about 60° C., or any value contained within a range formed by any two of the preceding values. In embodiments, treating the second portion of the graphene 113 includes applying a voltage of greater than or equal to about −10 V to less than or equal to about 10 V, such as about −10 V, about −9 V, about −8 V, about −7 V, about −6 V, about −5 V, about −4 V, about −3 V, about −2 V, about −1 V, about 0 V, about 0.5 V, about 1 V, about 1.5 V, about 2 V, about 2.5 V, about 3 V, about 3.5 V, about 4 V, about 4.5 V, about 5 V, about 5.5 V, about 6 V, about 6.5 V, about 7 V, about 7.5 V, about 8 V, about 8.5 V, about 9 V, about 9.5 V, about 10 V, or any value contained within a range formed by any two of the preceding values. In embodiments, step 113 includes both heating and applying a voltage as described herein. In embodiments, neither heating nor applying a voltage is included in step 113.

Step 114 of the disclosed method may, in embodiments, include filtering the final cathodic solution to isolate the holey graphene. Any method of liquid/solid filtration known to those skilled in the art is acceptable for use in the methods of the present disclosure. In embodiments, filtering the final cathodic solution to isolate holey graphene 114 further includes centrifuging the final cathodic solution to isolate the holey graphene.

In embodiments, the method disclosed herein may be used to produce graphene independently. For example, the method may include step 102 of providing an electrochemical cell and step 104 of exfoliating the anode to produce graphene, omit step 105 of separating the graphene into a first portion of graphene and a second portion of graphene, followed by performing step 106 of removing the graphene from the anodic compartment and step 108 of filtering the anodic solution to isolate graphene.

In embodiments, the method disclosed herein may be used to produce holey graphene independently. For example, the method may include step 102 of providing an electrochemical cell and step 104 of exfoliating the anode to produce graphene, omit step 105 of separating the graphene into a first portion of graphene and a second portion of graphene, followed by performing step 112 of transferring the graphene from the anodic compartment to the cathodic compartment, step 113 of treating the graphene to produce holey graphene, and step 114 of filtering the cathodic solution to isolate holey graphene.

In embodiments, the present disclosure also provides an electrode. The electrode may be a cathode, in embodiments. In embodiments, the electrode includes a metal or a metallic alloy, wherein the electrode is in the form of a triply periodic minimal surface having a defined unit cell geometry. Without wishing to be bound by theory, triply periodic minimal surfaces (TPMS) can be characterized by interconnected non-intersecting surfaces that split a given volume into two separate but continuous sub-volumes. In embodiments, TPMS possess a simultaneously high surface area and porosity. The size and wall thickness of the unit cell may also be readily adjustable due to the mathematically driven design.

The defined unit cell geometry of the electrode may, in embodiments, be a gyroid, a diamond, or a split-P. In embodiments, each of the gyroid, the diamond, and the split-P geometries are defined by equations, wherein x, y, and z are Cartesian coordinates and c is an offset parameter. In the following equations, the offset parameter c equals zero for a single unit cell of the TPMS.

In embodiments, the gyroid geometry is defined by the following equation:

$$c = sin ( x ) cos ( y ) + sin ( y ) cos ( x )$$

In embodiments, the diamond geometry is defined by the following equation:

$$c = sin ( x ) sin ( y ) sin ( z ) + sin ( x ) cos ( y ) cos ( z ) + cos ( x ) sin ( y ) cos ( z ) + cos ( x ) cos ( y ) sin ( z )$$

In embodiments, the split-P geometry is defined by the following equation:

$$c = 1.1 ( sin ( 2 x ) sin ( z ) cos ( y ) + sin ( 2 y ) sin ( x ) cos ( z ) + sin ( 2 z ) sin ( y ) cos ( x ) ) - 0.2 ( cos ( 2 x ) cos ( 2 y ) + cos ( 2 y ) cos ( 2 z ) + cos ( 2 z ) cos ( 2 x ) ) - 0.4 ( cos ( 2 x ) + cos ( 2 y ) + cos ( 2 z ) )$$

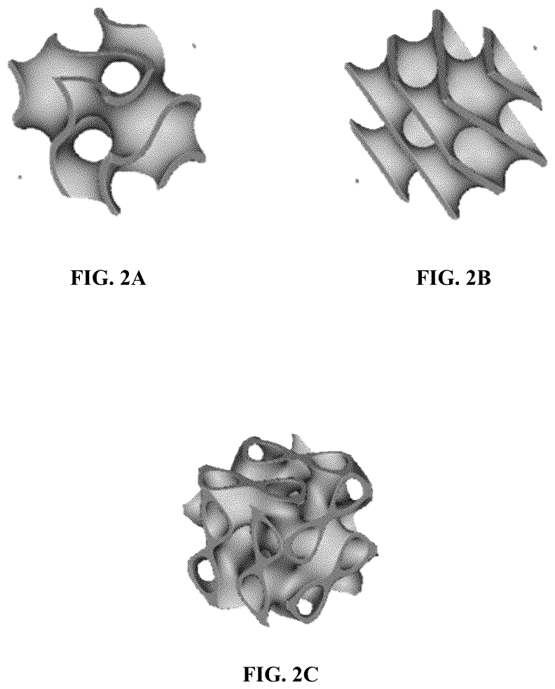

FIG. 2A, FIG. 2B, and FIG. 2C are modeled representations of single unit cells of triply periodic minimal surfaces, according to an embodiment of the present disclosure. FIG. 2A shows the unit cell of the gyroid geometry, FIG. 2B shows the unit cell of the diamond geometry, and FIG. 2C shows the unit cell of the split-P geometry. These geometries may be modeled in various software programs, according to embodiments of the present disclosure. The software that can be used to model these geometries is not limited, so long as the software is capable of performing such modeling, as would be familiar to one skilled in the art.

In embodiments, the electrode of the present disclosure was prepared to have the geometries disclosed herein. In embodiments, the electrode was further prepared to have a specific surface area similar to that found in metal foams, which may be beneficial in improving yields and efficiency in electrochemical processes including methods described herein. In embodiments and without wishing to be bound by theory, the specific surface area of the electrode allows improved fluid contact relative to other electrode configurations. In embodiments, the specific surface area is greater than or equal to about 1.0 mm²/mm³ to less than or equal to about 2.5 mm²/mm³. For example, the specific surface area of the electrode may be about 1.0 mm²/mm³, about 1.1 mm²/mm³, about 1.2 mm²/mm³, about 1.3 mm²/mm³, about 1.4 mm²/mm³, about 1.5 mm²/mm³, about 1.6 mm²/mm³, about 1.7 mm²/mm³, about 1.8 mm²/mm³, about 1.9 mm²/mm³, about 2.0 mm²/mm³, about 2.1 mm²/mm³, about 2.2 mm²/mm³, about 2.3 mm²/mm³, about 2.4 mm²/mm³, about 2.5 mm²/mm³, or any value contained within a range formed by any two of the preceding values.

In embodiments, the electrode has a porosity of greater than or equal to about 60% to less than or equal to about 85%, for example, about 60%, about 65%, about 70%, about 75%, about 80%, about 85%, or any value contained within a range formed by any two of the preceding values.

In embodiments, the electrode of the present disclosure is formed by 3D-printing. The size or other dimensional properties of the electrode are not particularly limited and may be selected according to the needs of a user of the electrode, the parameters of an electrochemical cell in which the electrode is to be used, or the parameters of the 3D-printing apparatus used to produce the electrode.

In embodiments, the present disclosure describes a method of producing graphene and holey graphene using the electrode described herein. Various embodiments of the present disclosure, such as embodiments towards methods of producing graphene and holey graphene and embodiments towards an electrode, may be used in combination. It is contemplated that the method of producing graphene and holey graphene as described herein may use any electrode known to those skilled in the art, including the electrode described herein. It is contemplated that the electrode described herein may be used in any electrochemical cell or electrochemical method known to those skilled in the art, including the method of producing graphene and holey graphene as described herein.

### Examples

Exemplary embodiments of the electrode of the present disclosure were prepared as described herein. Representative specific surface areas were chosen, and electrodes were prepared having the gyroid, diamond, and split-P unit cell geometries, using 3D printing methods. Various parameters for the unit cell geometries may change with the unit cell geometry and specific surface area, such as cell size, wall thickness, specific surface area, and porosity, as shown in TABLE 1.

TABLE 1

| | | | Wall | Specific | |
|---|---|---|---|---|---|
| | Unit Cell | Cell Size | Thickness | Surface Area | Porosity |
| Example | Geometry | (mm) | (mm) | (mm²/mm³) | (%) |
| 1 | Gyroid | 5.00 | 0.50 | 1.23 | 80.66 |
| 2 | Diamond | 6.25 | 0.50 | 1.23 | 81.58 |
| 3 | Split-P | 8.20 | 1.00 | 1.23 | 67.05 |
| 4 | Gyroid | 3.00 | 0.56 | 2.0 | 63.72 |
| 5 | Diamond | 3.75 | 0.54 | 2.0 | 66.52 |
| 6 | Split-P | 5.00 | 0.59 | 2.0 | 69.06 |

Electrodes were produced to 40×20×70 mm³ dimensions with gyroid, diamond, and split-P geometries and having surface areas of 1.23 mm²/mm³ and 2.0 mm²/mm³, according to an embodiment of the present disclosure.

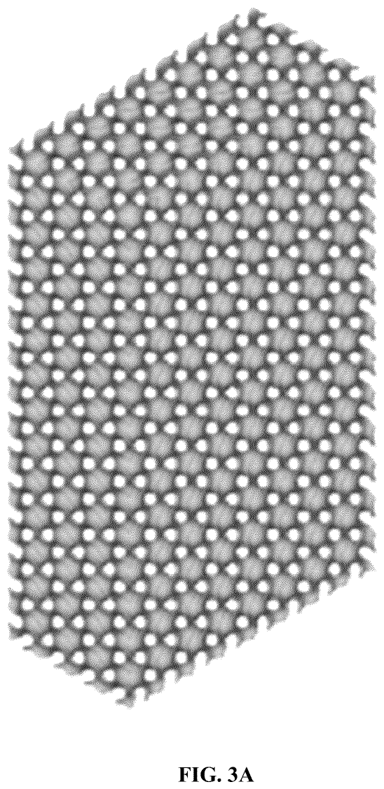

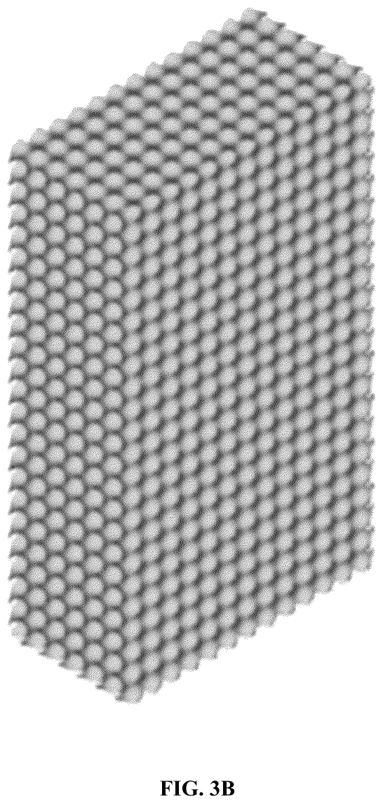

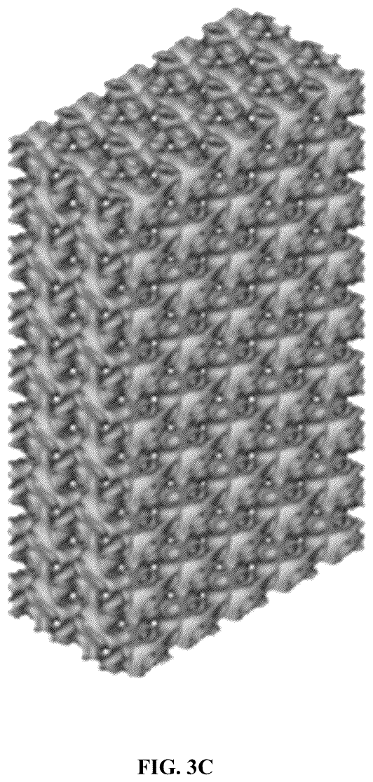

FIG. 3A is a modeled image of an electrode having a gyroid geometry and a specific surface area of 1.23 mm²/mm³, according to an embodiment of the present disclosure. FIG. 3B is a modeled image of an electrode having a diamond geometry and a specific surface area of 1.23 mm²/mm³, according to an embodiment of the present disclosure. FIG. 3C is a modeled image of an electrode having a split-P geometry and a specific surface area of 1.23 mm²/mm³, according to an embodiment of the present disclosure.

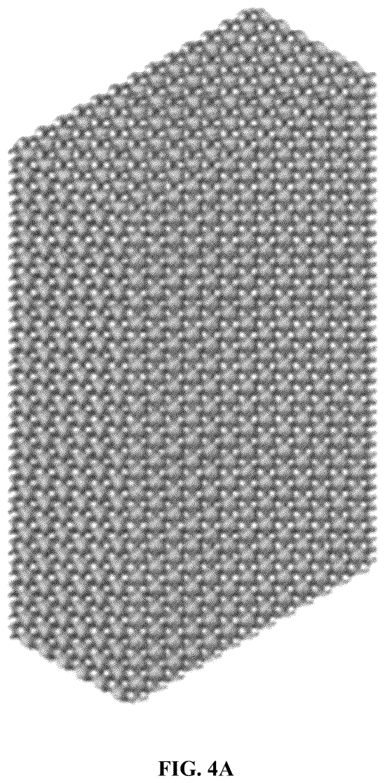

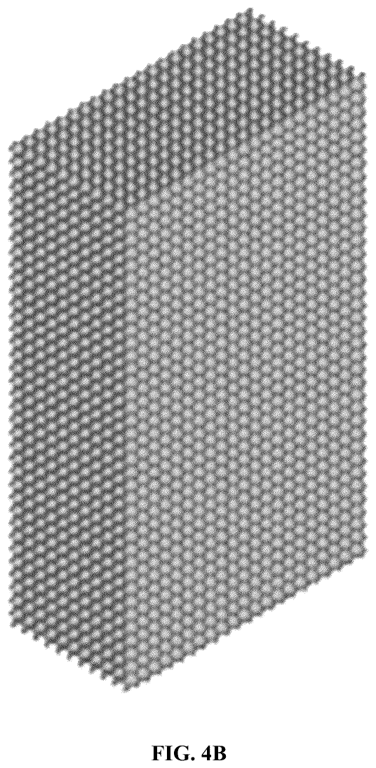

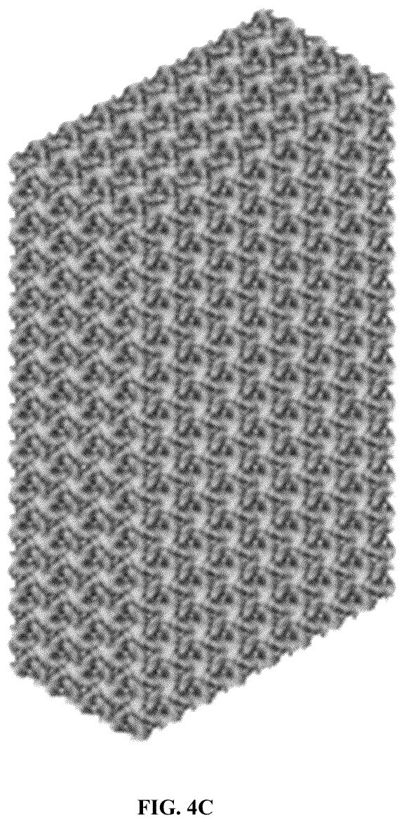

FIG. 4A is an image of an electrode having a gyroid geometry and a specific surface area of 2.0 mm²/mm³, according to an embodiment of the present disclosure. FIG. 4B is a modeled image of an electrode having a diamond geometry and a specific surface area of 2.0 mm²/mm³, according to an embodiment of the present disclosure. FIG. 4C is a modeled image of an electrode having a split-P geometry and a specific surface area of 2.0 mm²/mm³, according to an embodiment of the present disclosure.

The electrodes were additively manufactured using an aluminum alloy AlSi10Mg, with a chemical composition of about 10% silicon, about 0.3% magnesium, about 0.1% iron, about 0.005% manganese, and less than 0.005% each of copper, nickel, lead, antimony, tin, and zinc. The material was processed with a laser power of 400 W, a spot size of 0.09 mm, a scan speed of 1350 mm/s, a hatch spacing of 0.15 mm, a stripe width of 5 mm, and a layer thickness of 0.05 mm.

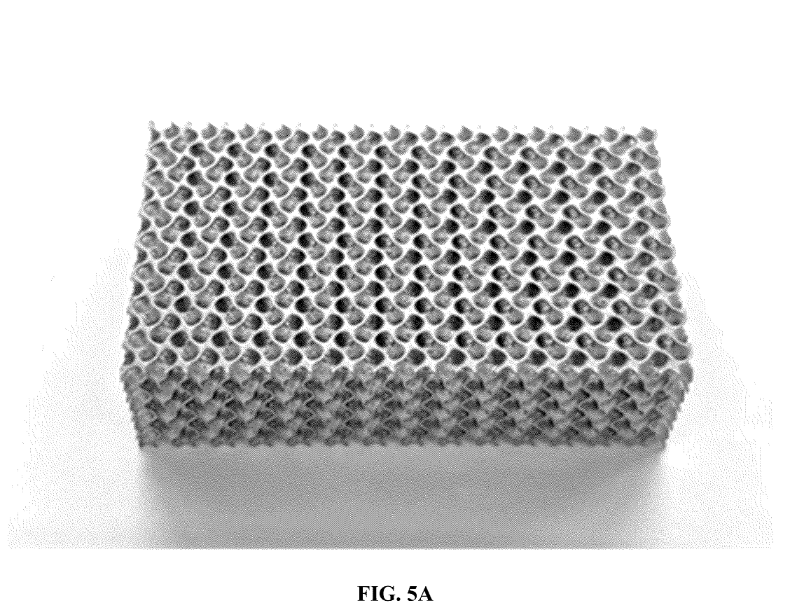

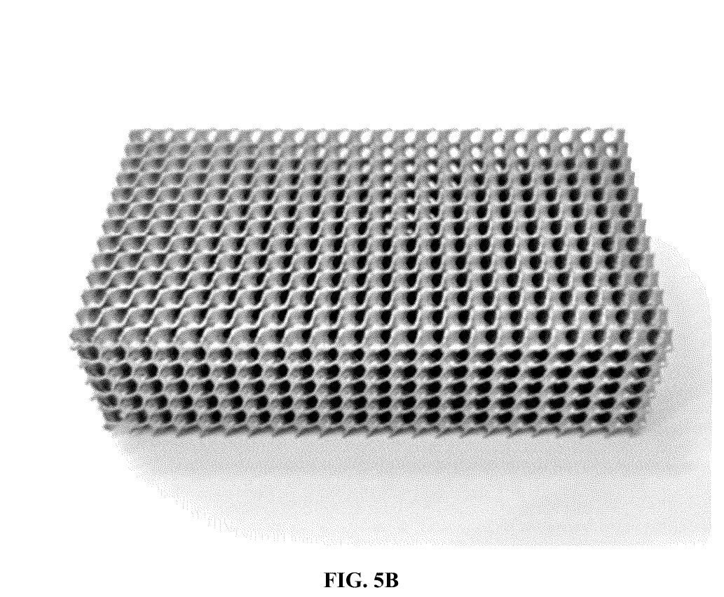

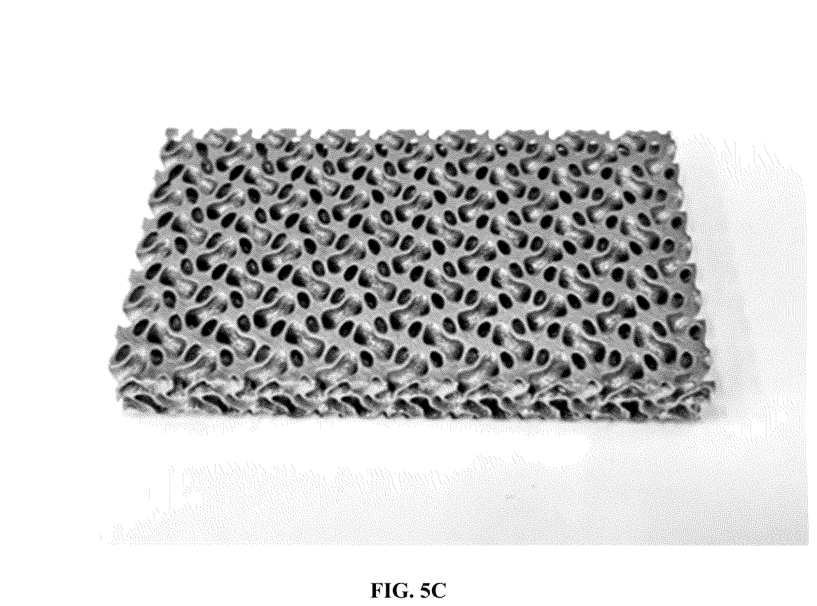

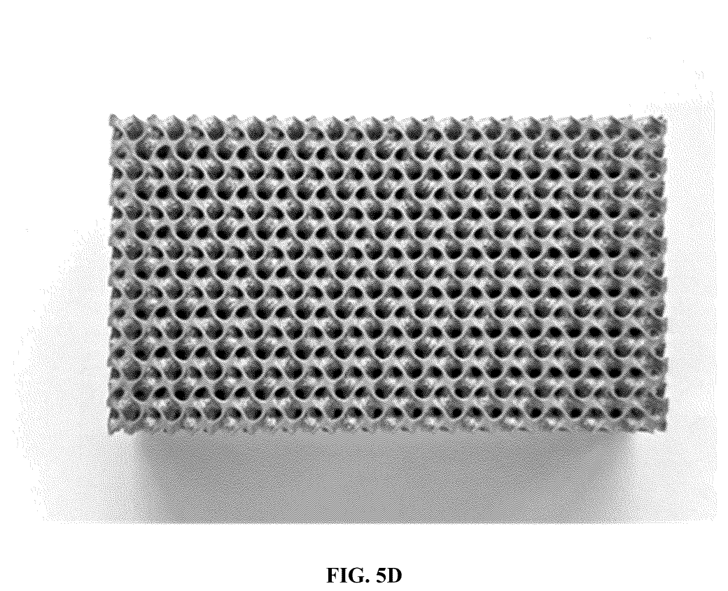

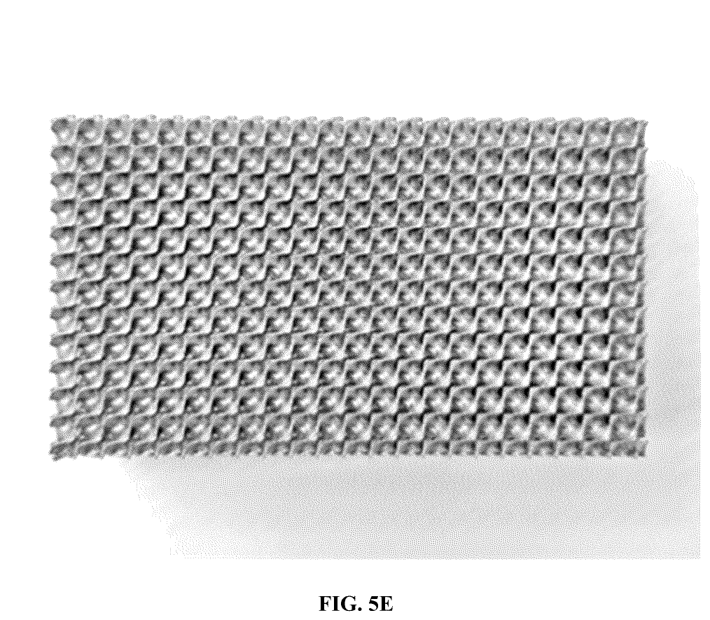

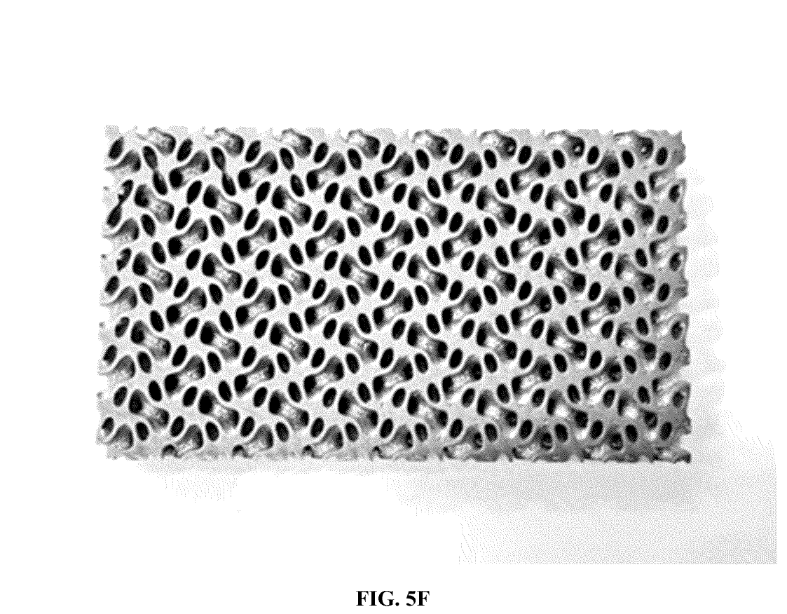

A titanium-containing alloy (Ti6Al4V ELI) was also used to prepare, via 3D printing, electrodes having the geometries disclosed herein. FIGS. 5A-5F are optical images of 3D-printed Titanium alloy electrodes, according to embodiments of the present disclosure. FIGS. 5A and 5D are electrodes having a gyroid geometry, FIGS. 5B and 5E are electrodes having a diamond geometry, and FIGS. 5C and 5F are electrodes having a split-P geometry.

The electrodes shown in FIGS. 5A-5F were used in an electrochemical cell according to embodiments of the present disclosure. The experimental analysis suggests the printed electrodes are nearly corrosion resistant to the chosen electrolyte within the parameters used, which suggests the longevity and reliability of the electrodes. The anionic membrane separating the cells was glued on a glass beaker using a commercially available transparent silicone glue. For the reaction process to start, the reduction cell (with the 3D printed electrode) was connected to negative potential. In the oxidation cell, graphite foil/film/block was used which was then connected to positive potential. The graphene exfoliation occurs in the oxidation (anodic) cell and was then transferred to the reduction (cathodic) cell for the holey graphene production.

Following the completion of the reaction process, the synthesized materials from the cells were filtered separately using a vacuum filtration unit using deionized water. Deionized water was used during the process to filter and remove any residue of the acid solution. The filtered materials were then collected separately. The obtained materials then can be mixed with dimethylformamide ((CH₃)₂NC(O)H), N-methylpyrrolidone (NMP), or deionized water to make a dispersed solution with varying graphene or holey-graphene concentrations. A mild bath sonication for 5-10 minutes was used to disperse the materials in solution. Subsequently, the dispersed solutions were drop-casted on a doped Si wafer substrate for further analysis using scanning electron microscopy (SEM), Raman spectroscopy, and X-ray photoelectron spectroscopy (XPS) techniques. Other substrates may also be acceptable.

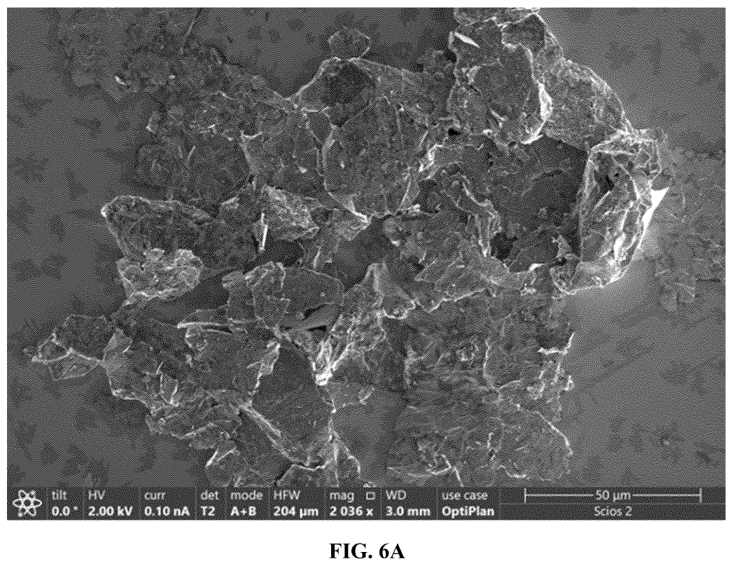

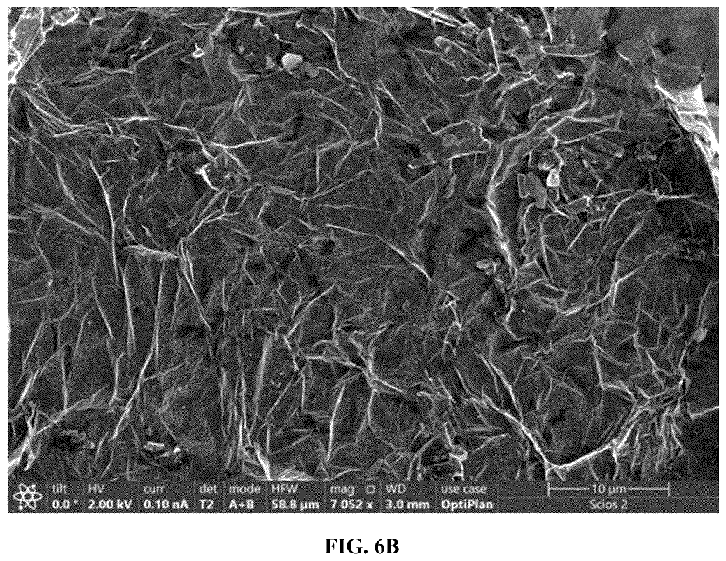

FIGS. 6A and 6B are SEM images of the graphene flakes obtained from the oxidation (anodic) cell, according to embodiments of the present disclosure. FIGS. 6A and 6B show the scanning electron microscopy (SEM) images (low magnification and high magnification, respectively) of the graphene flakes obtained from the oxidation cell (anodic solution). The flake size could be in the few hundred nm to few tens of micron range. The thickness of the flakes can vary from a few nanometers to tens of nanometers. The size or the thickness of the flakes depends on the cathode (graphite foil/block/film) type as well as on the parameters used in the electrochemical reaction, without wishing to be bound by theory.

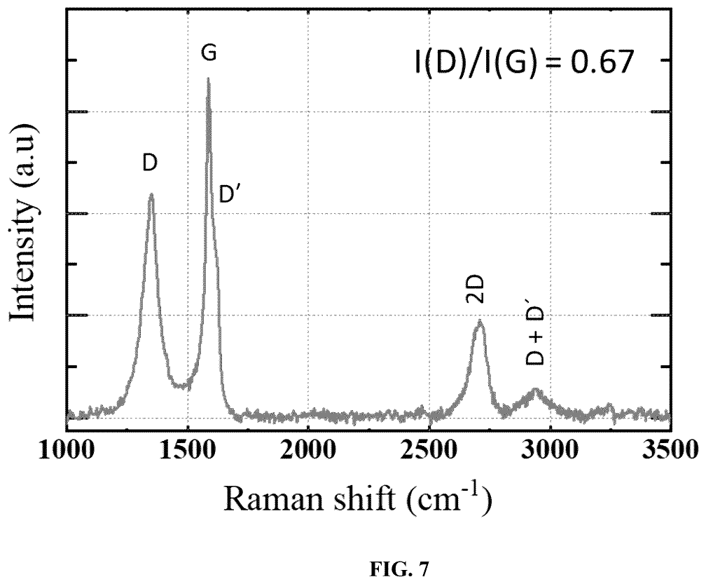

FIG. 7 is a graph of Raman shift obtained from the graphene and holey graphene flakes of the oxidation cell (anodic compartment), according to an embodiment of the present disclosure. FIG. 7 shows major peaks D (1350.88 cm⁻¹), G (1589.64 cm⁻¹) and 2D (2707.68 cm⁻¹) along with a shoulder peak D′ at 1620.13 cm⁻¹ and D+D′ peak at 2941.67 cm⁻¹ were observed. The peaks indicate the graphitic nature of the graphene flakes as well as the presence of defects which are expected to be present after the electrochemical exfoliation process.

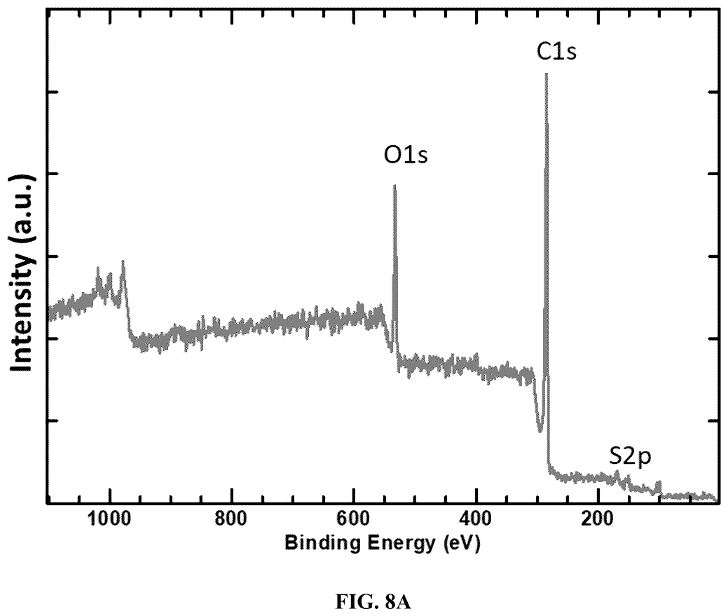

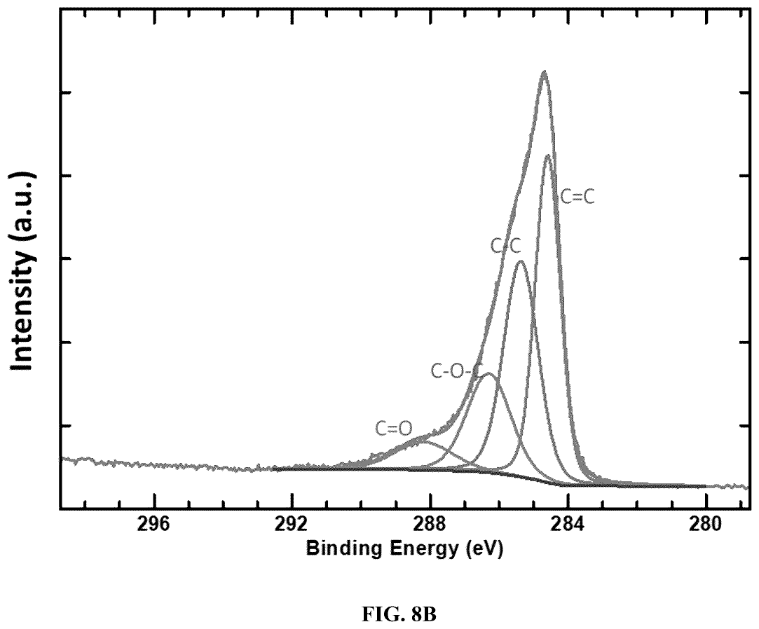

FIGS. 8A and 8B are an XPS survey scan and a high-resolution scan, respectively, of the C1s peak obtained from the oxidized flakes, according to an embodiment of the present disclosure. The survey scan indicates the elemental presence of oxygen and carbon and minor traces of elemental sulfur. The deconvolution of the C1s indicates the presence of different functional groups present in the exfoliated flakes. The combined C—O+C═O contributes 27.59 atom % composition to the C1s peak.

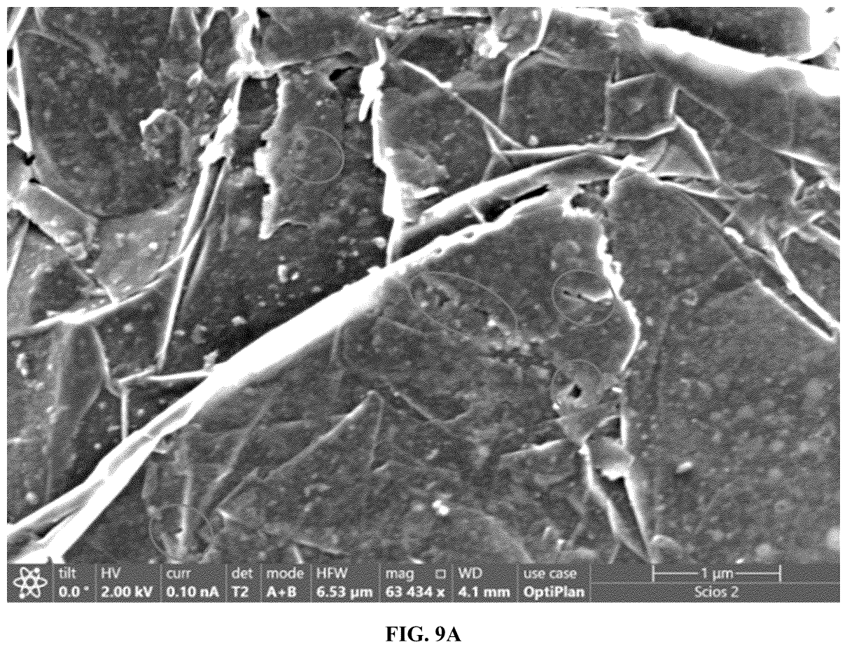

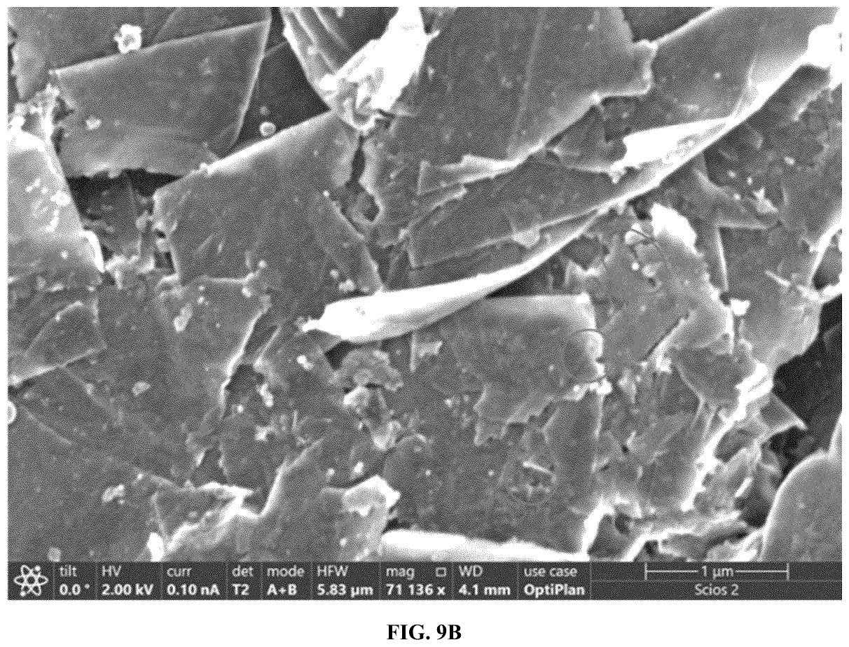

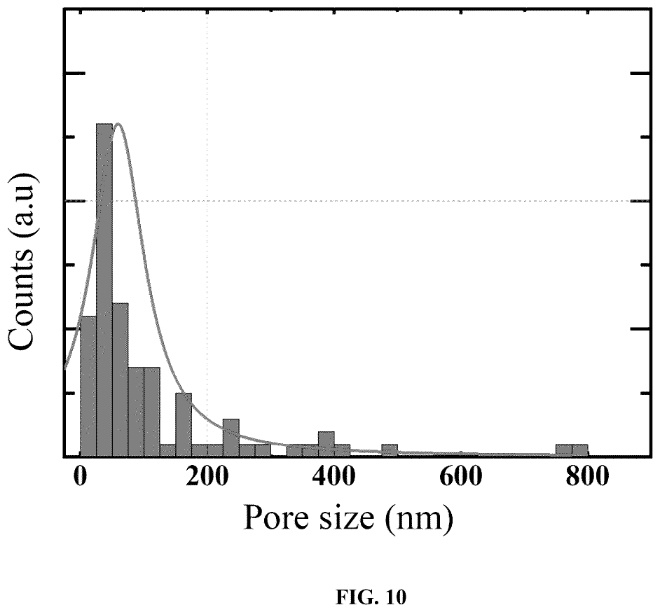

FIGS. 9A and 9B are SEM images of the holey graphene flakes obtained from the reduced cell (cathodic cell), according to an embodiment of the present disclosure. The formation of pores on the flakes can be clearly seen in FIGS. 9A and 9B and are marked by the circled portions of the images. The range of these pores can vary from few nanometers to hundreds of nanometers. Analysis from the scanning electron microscopy images provides a distribution of the pores which is shown in FIG. 10. FIG. 10 is a graph of pore-size distribution of the graphene obtained by the present method, according to an embodiment of the present disclosure. The distribution depends on various parameters such as electrolyte concentration, duration of the reaction, applied electrical voltage and current, and the like.

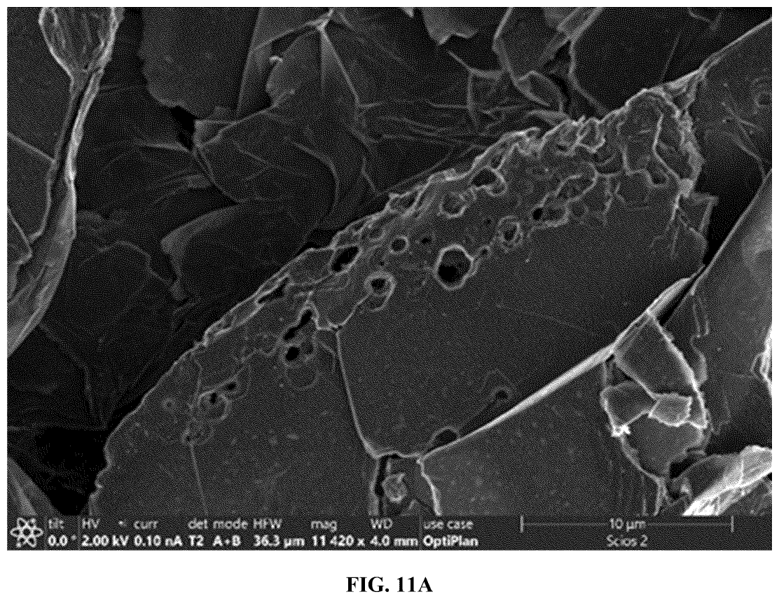

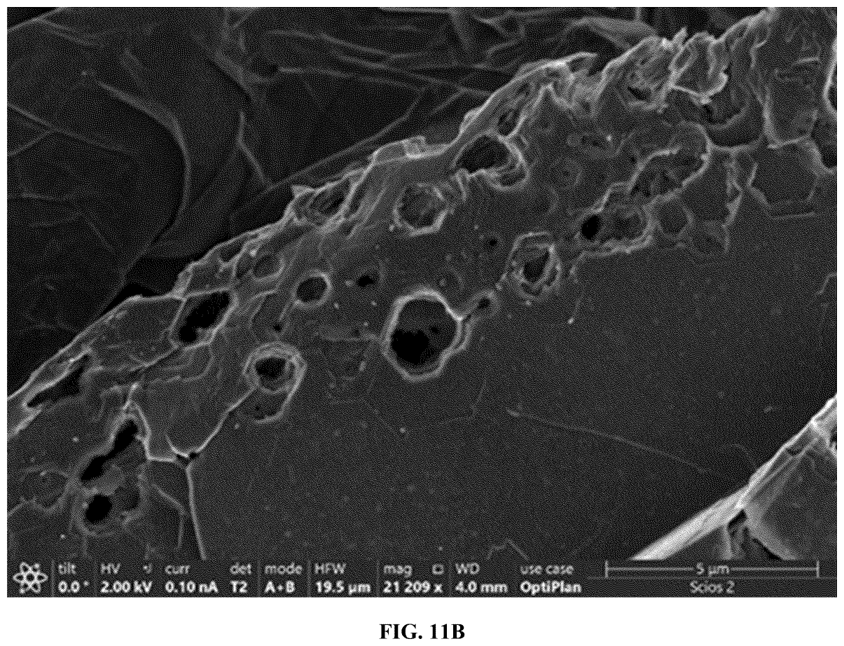

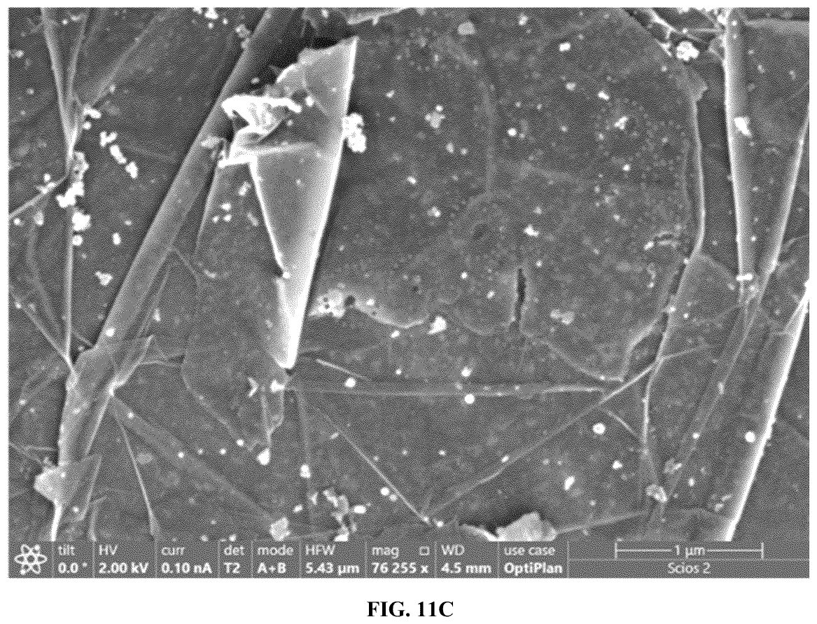

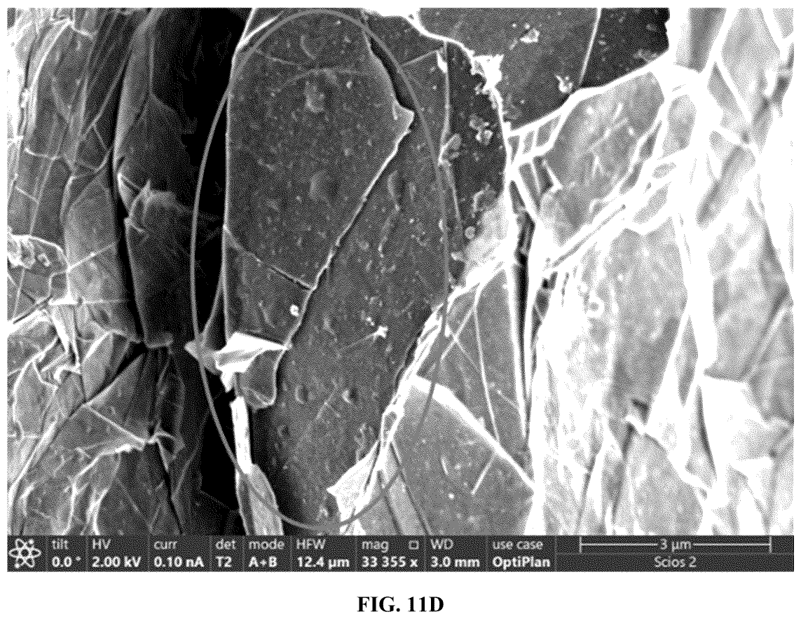

In some cases, surface modification can be observed instead of through-holes, which can occur due to reduction of the functional groups on several layers of the material. Reduction of these functional groups may continue as long as there is a presence of such groups. The reduction process can terminate as soon as the functional groups are removed, which may result in complete through-holes in the material or in pores forming through several layers of the material. It was also observed that the edges of the flakes are more prone to being etched away. This tendency could be due to the fact that the exfoliation of the flakes starts from the edges by the ion intercalation process, which can cause the edges to be functionalized more readily than at the basal planes of the flakes. The etched edges usually appear in an irregular shape. In addition, at the grain boundaries of the graphene crystallites are non sp² regions where the carbon atoms can interact with the sulfate ions more easily. The reduction of these regions leads to the formation of pores. This pore formation can be seen on certain flakes that exhibit a void in non-circular form (such as line or elliptical shape), which is shown in FIGS. 11A-11D. FIGS. 11A, 11B, 11C, and 11D are SEM images of graphene flakes obtained from the reduced cell at differing magnifications as evidenced by a scale of 10 μm, 5 μm, 1 μm, and 3 μm, respectively, according to an embodiment of the present disclosure. The irregular shapes of pores can be seen as circled in FIGS. 11C and 11D.

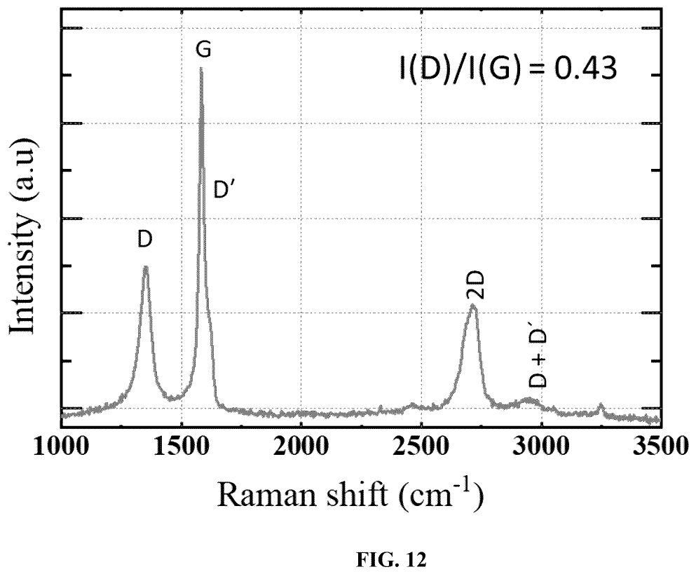

FIG. 12 is a graph of the Raman spectrum obtained from the graphene flakes of the reduced cell (cathodic cell), according to an embodiment of the present disclosure. Raman study on the holey graphene flakes as in FIG. 12 indicates the presence of D (1350.88 cm⁻¹), G (1584.96 cm⁻¹) and 2D (2710.93 cm⁻¹) peaks. Additional peaks D′ (1623.74 cm⁻¹) and D+D′ (˜ 2951 cm⁻¹) are also observed.

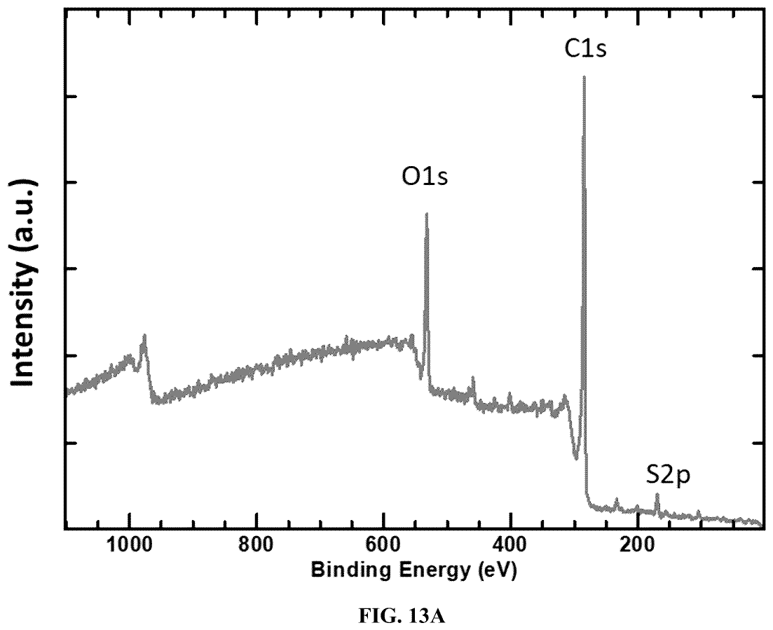

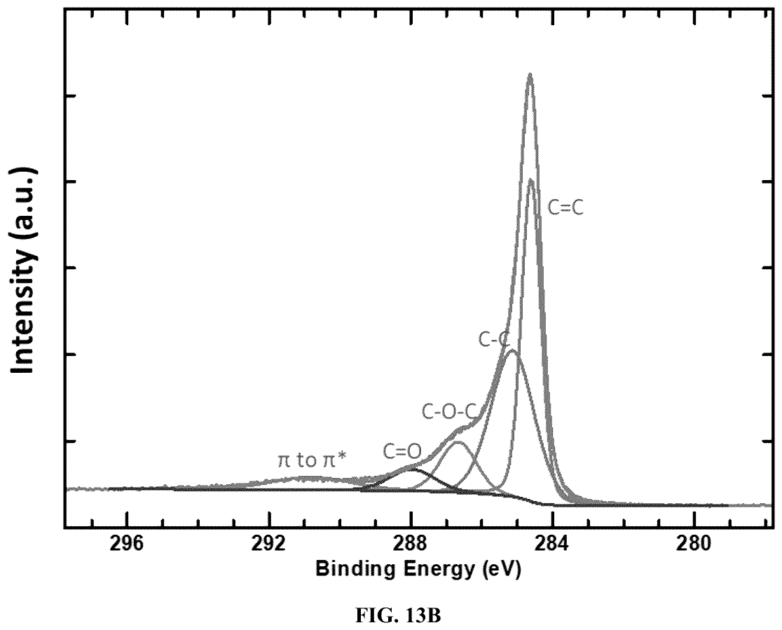

FIGS. 13A and 13B are an XPS survey spectrum and high-resolution C1s spectrum, respectively, obtained from the reduced flakes, according to an embodiment of the present disclosure. Further, XPS investigation was conducted on the holey graphene samples. The results are provided in FIGS. 13A and 13B. The survey in FIG. 13A indicates the presence of carbon and oxygen and a minor amount of sulfur. Deconvolution of the carbon peaks shows the contribution of different functional groups. The combined contribution of C—O and C═O is around 17.85 atom %. This value is lower than oxidized sample and signifies an approximately 35% decrease in the functional groups as a result of the reduction process.

The method of producing graphene and holey graphene described herein can be performed with a highly selective ion exchange membrane with an exchange capacity of 1/1 meq/g that withstands a maximum current of 50 amp/ft² and is stable up to 80° C. The electrochemical cell used in the present method uses an additively manufactured cathode of AlSi10Mg and Ti6Al4V ELI as described herein and an anode of graphite (99% purity, maximum grain size of 0.04 mm). The geometry of the anode may be square or rectangular or circular. Approximately 5 g to 10 g of graphene and holey graphene per liter of anodic and cathodic solution may be obtained using the method of the present disclosure, without wishing to be bound by theory.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%, and also includes exactly 50%. Any value modified by “about” as disclosed herein also discloses the exact value.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A method of producing graphene and holey graphene, the method comprising:
providing an electrochemical cell comprising a cathodic compartment containing a cathode and an initial cathodic solution, and an anodic compartment containing an anode and an initial anodic solution;
exfoliating the anode to produce graphene in a final anodic solution;
separating the graphene in the final anodic solution into a first portion of graphene and a second portion of graphene;
removing the first portion of graphene from the anodic compartment;
filtering the first portion of graphene to isolate the graphene;
transferring the second portion of graphene from the anodic compartment to the cathodic compartment;
treating the second portion of graphene to produce holey graphene in a final cathodic solution; and
filtering the final cathodic solution to isolate the holey graphene.

2. The method of claim 1, wherein the cathodic compartment and the anodic compartment are separated by an anionic membrane.

3. The method of claim 2, wherein the anionic membrane comprises polystyrene, polyethylene, polysulfone, ammonium, or combinations thereof.

4. The method of claim 1, wherein the anode comprises graphite.

5. The method of claim 1, wherein the cathode comprises a metal or a metallic alloy in the form of a triply periodic minimal surface having a defined unit cell geometry.

6. The method of claim 5, wherein the defined unit cell geometry is a gyroid, a diamond, or a split-P.

7. The method of claim 1, wherein the initial anodic solution comprises sulfuric acid, ammonium sulfate, or combinations thereof.

8. The method of claim 1, wherein the initial cathodic solution comprises sulfuric acid, ammonium sulfate, or combinations thereof.

9. The method of claim 1, wherein exfoliating the anode comprises stirring, heating to a temperature of greater than or equal to 10° C. to less than or equal to 60° C., applying a voltage of greater than or equal to −10 V to less than or equal to 10 V, or combinations thereof.

10. The method of claim 1, wherein treating the second portion of graphene comprises contacting the second portion of graphene with the initial anodic solution in the cathodic compartment, heating to a temperature of greater than or equal to 10° C. to less than or equal to 60° C., applying a voltage of greater than or equal to −10 V to less than or equal to 10 V, or combinations thereof.

11. The method of claim 1, wherein the method further comprises centrifuging the final anodic solution to isolate the graphene, centrifuging the final cathodic solution to isolate the holey graphene, or centrifuging both the final anodic solution to isolate the graphene and the final cathodic solution to isolate the holey graphene.

12. The method of claim 1, wherein the method further comprises recycling the final cathodic solution and the final anodic solution.

13. An electrode, comprising: a metal or metallic alloy, wherein the electrode is in the form of a triply periodic minimal surface having a defined unit cell geometry.

14. The electrode of claim 13, wherein the defined unit cell geometry is a gyroid, a diamond, or a split-P.

15. The electrode of claim 14, wherein:
the gyroid is defined by the equation:
$$c = sin ( x ) cos ( y ) + sin ( y ) cos ( x ) ;$$
the diamond is defined by the equation:
$$c = sin ( x ) sin ( y ) sin ( z ) + sin ( x ) cos ( y ) cos ( z ) + cos ( x ) sin ( y ) cos ( z ) + cos ( x ) cos ( y ) sin ( z ) ; and$$
the split-P is defined by the equation:
$$c = 1.1 ( sin ( 2 x ) sin ( z ) cos ( y ) + sin ( 2 y ) sin ( x ) cos ( z ) + sin ( 2 z ) sin ( y ) cos ( x ) ) - 0.2 ( cos ( 2 x ) cos ( 2 y ) + cos ( 2 y ) cos ( 2 z ) + cos ( 2 z ) cos ( 2 x ) ) - 0.4 ( cos ( 2 x ) + cos ( 2 y ) + cos ( 2 z ) ) ;$$
wherein x, y, and z are Cartesian coordinates and c is an offset parameter.

16. The electrode of claim 13, wherein the metal or metallic alloy comprises aluminum, titanium, silicon, magnesium, iron, or combinations thereof.

17. The electrode of claim 13, wherein the electrode has a specific surface area of greater than or equal to 1.0 mm²/mm³ to less than or equal to 2.5 mm²/mm³.

18. The electrode of claim 13, wherein the electrode has a porosity of greater than or equal to 60% to less than or equal to 85%.

19. A method of producing graphene and holey graphene, using the electrode of claim 13.

20. The method of claim 19, wherein the method comprises:
providing an electrochemical cell comprising a cathodic compartment containing a cathode and an initial cathodic solution, and an anodic compartment containing an anode and an initial anodic solution;
exfoliating the anode to produce graphene in a final anodic solution;
separating the graphene in the final anodic solution into a first portion of graphene and a second portion of graphene;
removing the first portion of graphene from the anodic compartment;
filtering the first portion of graphene to isolate the graphene;
transferring the second portion of graphene from the anodic compartment to the cathodic compartment;
treating the second portion of graphene to produce holey graphene in a final cathodic solution; and
filtering the final cathodic solution to isolate the holey graphene.
